(19) United States
(12) Patent Application Publication
(10) Pub. No.: US 2004/0212550 A1
(43) Pub. Date: Oct. 28, 2004

(54) Three-dimensional volumetric display

(76) Inventor: Zhan He, Bedford Hills, NY (US)

Correspondence Address: Gerow D. Brill, Esq., Reveo, Inc., 85 Executive Boulevard, Elmsford, NY, 10523, US

(21) Appl. No.: 09/739,519

(22) Filed: Dec. 15, 2000

Related U.S. Application Data
(60) Provisional application No. 60/171,075, filed on Dec. 16, 1999.

(51) Int. Cl. G09G 5/00

(52) U.S. Cl. 345/6

(57) ABSTRACT

A novel three-dimensional (3D) volumetric display device is disclosed. The 3D volumetric display device of this invention includes a microlens array and an electrical control device for controlling the depth position of individual volume points within the 3D volumetric image. The display device of this invention displays 3D images that may be observed without the use of eyewear. The display device of this invention may further provide for monochromatic or full color 3D displays having a large depth of field. Moreover, the display device of this invention may provide for compact and lightweight 3D displays and may be suitable for many portable electronic applications.

### BACKGROUND OF THE INVENTION

(i) Field of the Invention

The present invention relates generally to a novel three-dimensional (3D) volumetric display device and more particularly to 3D volumetric display device not requiring special glasses.

(ii) Background Information

The human environment is and always has been saturated with three-dimensional (3D) information. However, in the modern era, human communication has almost exclusively been limited to the realm of two-dimensional (2D) conveyance. Most modern communications technologies such as television, print, projection, and computer display are limited to 2D. Although these technologies are maturing in their information content, they are fundamentally, and in a humanitarian sense, tragically limited by this unfortunate fact.

Many approaches have been presented to achieve 3D image displays. Conventional 3D display technologies referred as to stereoscopic 3D technology utilize eyewear, where each eye (left or right) can only receive one image corresponding to left or right image by either a different color, a different polarization, or, in a fast shutter technique, an entire interlaced time-resolved image. U.S. Pat. Nos. 5,553,203, 5,844,717 and 5,537,144 to S. M. Faris are examples of technology using different polarization. The above-cited Faris patents are herein fully incorporated by reference. Based on those patents, Reveo Incorporated, the assignee of this application, has previously invented, developed, and commercialized a 3D display technology using a micropolarizer panel (μPol™), in which alternate lines (line widths on the order of hundreds of microns) having perpendicular polarization states are used. These and similar technologies can be viewed by large groups of people and have been successfully commercialized in limited markets, but they are far from ideal owing to their requirement of additional eyewear.

A few 3D display technologies that do not require special glasses have been developed using image splitting technology or lenticular screen technology. See articles by H. Isosno, et al., (in Asia Display'95, p. 795) and G. Hamagishi, et al., (in Asia Display'95, p.791) both herein fully incorporated by reference. However, only when the viewer sits in a certain predetermined position, does a geometric masking effect allow the left eye to see the left eye image, and vice versa. Thus, the distances and viewing areas of these technologies tend to be limited, rendering group viewing a near impossibility.

A nearly ideal 3D display technology is holography, which can display a real 3D image in space. Since the image floats in space, every viewer can observe this image from almost all directions and without any encumbering eyewear. This technology has been discussed in many books and articles such as P. H. Harihanp's book “Optical Holography: Principles, Techniques, and Applications” (Cambridge University Press, July 1996), which is herein fully incorporated by reference. Generally speaking, this technology needs a very high resolution recording media (at least >1,000 line pairs/mm). With the exception of specialized photosensitive films or plates, it is generally difficult to digitally store or reconstruct such high spatial frequency information using the present opto-electronic recording (such as CCD cameras) or display devices (CRT or liquid crystal display (LCD) panels). Practical application of holography, therefore, tends to be

One alternative technology is 3D volumetric display. A 3D volumetric image is typically created by scanning one or more laser light beams on moving/rotating screen surfaces to generate scattering light points. A series of light points builds up a 3D image in space. Batchko, in U.S. Pat. No. 5,148,310, used a rotating flat screen within a cylinder. Anderson, in U.S. Pat. No. 5,220,452, disclosed a rotating helix screen. Garcia et al., in U.S. Pat. No. 5,172,266, disclosed a disk-shaped screen half-circle with symmetrical steps. Some technologies utilize rotation of flat display panels such as LED arrays to create 3D light emission points as disclosed in U.S. Pat. No. 4,160,973 by Berlin, Jr. Additionally, B. Ciongoli has described, in U.S. Pat. No. 4,692,878, a rotating lens that images a 2D image into 3D space. The maximum size of this type of display tends to be limited by mass and inertia considerations related to the moving screens. Also, high-speed mechanical rotation may be dangerous and unstable. Each of the patents cited in this paragraph are herein fully incorporated by reference.

Another approach is to generate a 3D image by using a varifocal mirror to reflect a series of 2D images to different 3D positions as disclosed by King, in U.S. Pat. No. 3,632,184, Thomson et al., in U.S. Pat. No. 4,462,044, and Fuchs et al., in U.S. Pat. No. 4,607,255. The King, Thomson et al., and Fuchs et al. patents are herein fully incorporated by reference. As disclosed in the above-cited patents, a varifocal mirror is fabricated by stretching a Mylar sheet over a loudspeaker, the focal length of the mirror being controlled by electrical signals. This type of 3D display technology is typically limited by both the relative lack of speed and range of depth of the display panel. Recently, Suyama et al., in Jpn. J. Appl. Phys., vol. 39, p. 480 (2000), described the use of a liquid crystal varifocal lens. The Suyama, et al., article is herein fully incorporated by reference. The authors used liquid crystals to build a large aperture lens, which consisted of a LC region and a Fresnel lens sandwiched between two transparent electrode substrates. Upon a change in the applied voltage, the LC molecules were forced to orient along the electric field, which induced a change in the effective refractive index, resulting in a variable focal length lens. Using this lens, the authors projected 2D images into 3D space, thereby generating 3D images.

Yet another 3D display technology involves scanning two or more laser beams within a gas or transparent solid. Fluorescent emission is induced at intersection points of the laser beams. This technology is disclosed by Korevaar et al., in U.S. Pat. No. 4,881,068, DeMond et al., in U.S. Pat. No. 5,214,419, and Downing, in Science, vol. 273, p. 1185-1189 (1996). The Korevaar et al., and DeMond et al., patents and the Downing article are herein fully incorporated by reference. This technology, however, tends to be difficult to scale up for producing large images, owing to optical density and mass constraints.

One alternative is a 3D volumetric display technology recently presented by Dolgoff, in Proceeding of SPIE, vol. 3296, p. 225 (1998), which is herein fully incorporated by reference. An expanded light beam is converged to a point in 3D space. An XY scanner scans the 2D plane, while a varifocal mirror, or rotating wheel including different focal length mirrors, or holograms, scans the depth direction. Thus, a series of 3D light points representing a 3D image may be created in 3D space if the volumetric scanning can be accomplished at high speeds. This technology requires a complicated mechanical scanning system and real-time mechanical adjustment of mirror focal length and therefore tends to be limited by the mechanical mechanism and scanning speed constraints. Stability may also be an issue.

There exists a need, therefore, for a novel 3D volumetric display technology in which the 3D image display may be electrically controlled.

### SUMMARY OF THE INVENTION

One aspect of the present invention includes a novel three dimensional volumetric display device, which includes an active microlens array and an electrical control for controlling a depth position of individual displayed points of the three-dimensional volumetric image. Another aspect of this invention includes a method for displaying a three-dimensional volumetric image.

One feature of the 3D volumetric display device of this invention is that it does not require eyewear such as that used in stereoscopic technologies. Another feature of this invention is that it may provide a large viewing angle suitable for group viewing. Yet another feature of this invention is that the 3D information used in this technology may be easily digitized and transferred electronically. Still another feature of this invention is that it may provide a full color 3D volumetric display. Further, the 3D volumetric display device of this invention may be fabricated as a flat panel, similar to a LCD panel, and therefore may provide a lightweight and compact 3D volumetric display device for portable electronic applications.

In one embodiment, the 3D volumetric display device of this invention includes a variable focal length microlens array and an electrical control device that controls the focal length of each individual microlens in the microlens array.

In another embodiment, the 3D volumetric display device of this invention includes a variable focal length microlens array, an electrical control device that controls the focal length of each individual microlens in the microlens array, and a LCD flat panel, wherein the optical axis of each microlens in the microlens array is coincident with the optical axis of the corresponding pixel in the LCD.

In yet another embodiment, the 3D volumetric display device of this invention includes an active microlens array, an electrical control device that controls the focal length of each individual microlens in the first microlens array, and a passive microlens array, wherein the optical axis of each microlens in the first microlens array is coincident with the optical axis of the corresponding microlens in the second microlens array.

In still another embodiment, the 3D volumetric display device of this invention includes an active microlens array, an electrical control device that controls the focal length of each individual microlens in the first microlens array, a passive microlens array, and a LCD flat panel, wherein the optical axis of each microlens in the first microlens array is coincident with the optical axis of the corresponding microlens in the second microlens array and with the optical axis of the corresponding pixel in the LCD.

These and other objects of the present invention will become apparent hereinafter in the claims to the invention.

### BRIEF DESCRIPTION OF THE DRAWINGS

For a more complete understanding of the present invention, the detailed description is to be read in conjunction with the following drawings, in which:

FIG. 1 is a schematic of a first embodiment of the invented 3D volumetric display device using a variable focal length microlens array;

FIG. 2 is a schematic illustrating the principle by which a microlens array focuses incident light to form a 3D volumetric image;

FIG. 3A is a schematic of an asymmetric LC microlens design;

FIG. 3B is a schematic cross sectional view of the asymmetric microlens of FIG. 3A showing electric field lines upon the application of a voltage;

FIG. 4A is a schematic of a symmetric LC microlens design;

FIG. 4B is a schematic cross sectional view of the symmetric microlens of FIG. 4A showing electric field lines upon the application of a voltage;

FIG. 5 is a plot of focal length versus applied voltage for an asymmetric LC microlens having a diameter of 250 μm and a thickness of 100 μm;

FIG. 6 is a plot of focal length versus applied voltage for a symmetric LC microlens having a diameter of 250 μm and a thickness of 100 μm;

FIG. 7 is a schematic top view of a section of a LC microlens array using a passive matrix driving scheme;

FIG. 8 is a schematic top view of a section of a LC microlens array using an active matrix driving scheme;

FIG. 9 is a schematic of a second embodiment of the invented 3D volumetric display device combining a variable focal length microlens array and a LCD flat panel;

FIG. 10 is a schematic of a third embodiment of the invented 3D volumetric display device combining a variable focal length microlens array and a passive microlens array;

FIG. 11 illustrates the principle by which a third embodiment achieves depth-enhancement;

FIG. 12 is a plot of the final focal length (L) versus the focal length (f_{LC}) of the LC microlens when the distance (1) is greater than f_{Glass}+maximum f_{LC};

FIG. 13 is a plot of the final focal length (L) versus the focal length (f_{LC}) of the LC microlens when the distance (l) is less than f_{Glass}+minimum f_{LC};

FIG. 14 is a schematic of a third embodiment 3D volumetric display device, which may generate real or imaginary 3D images;

### DETAILED DESCRIPTION

The three-dimensional volumetric display device disclosed herein includes a microlens array and an electrical control device that may control the depth position of each volume point in the 3D volumetric image. It is preferred that the electrical control device controls the position of each volume point by controlling the focal length of each individual microlens in the microlens array.

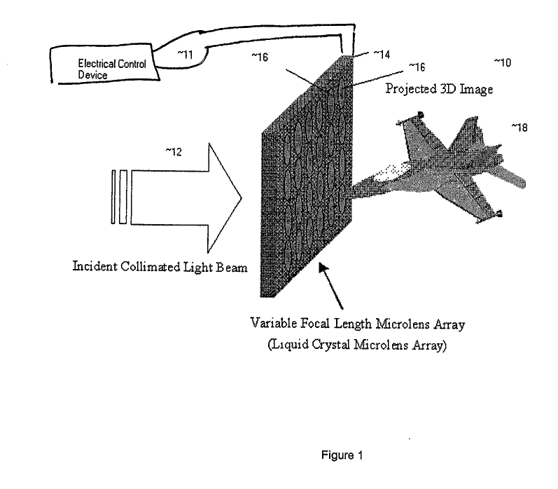

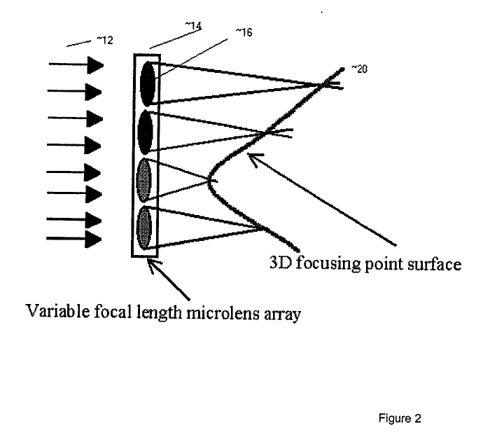

One embodiment 10 of the 3D volumetric display device of the present invention is illustrated in FIG. 1. Collimated light 12 is incident on a variable focal length microlens array 14. Collimated light 12 may originate from any source. For example, it may be provided by collimating a point light source, such as laser. It may be further provided by collimating an area light source, such as a diode laser array with a microlens collimator array. The variable focal length microlens array 14 may be any type of microlens array 14 in which the focal length of each microlens 16 may be individually controlled by an electrical control device 11. A liquid crystal microlens array is one example and is discussed in more detail below. FIG. 2 illustrates the principle by which microlens array 14 focuses incident light to form a 3D object surface 20. Since the light focal points truly exist in 3D space, eyewear may not be required to see the 3D images, which appear as though actually reflected from an object. The displayed images may be viewed with continuous parallax, both vertically and horizontally.

As mentioned hereinabove, an optical element for the 3D volumetric display device of this invention is the variable focal length microlens array 14. A liquid crystal microlens array may be utilized, wherein the individual microlenses have hole-patterned electrode structures. Individual microlenses of this type have been previously described by Nose, et al., in Liq. Cryst., vol. 5, p. 1425 (1989) and He, et al., in Jpn. J. Appl. Phys., vol. 33, p. 1091 (1994) and Jpn. J. Appl. Phys., vol. 34, p. 2392 (1995). The Nose et al., and He et al., articles are herein fully incorporated by reference. When a liquid crystal microlens array is utilized, electrical control device 11 may be similar to that used in conventional LCD flat panels. As shown hereinbelow, electrical control device 11 may drive each microlens in the liquid crystal microlens array with a desirable voltage to realize a predetermined depth.

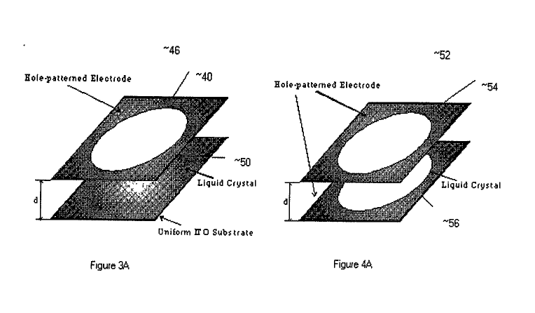

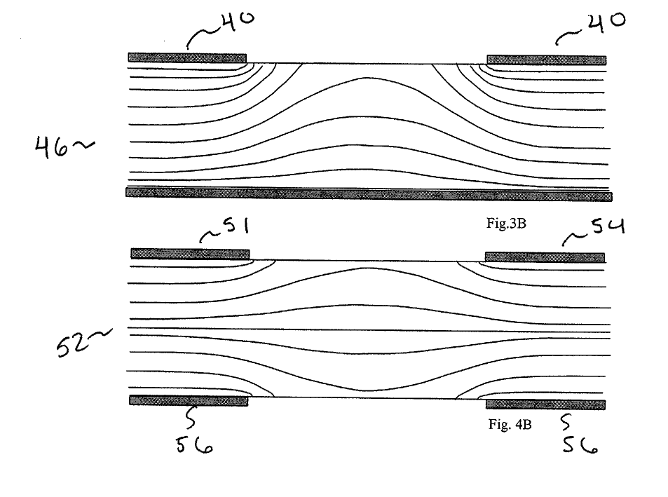

Referring now to FIGS. 3 and 4, two basic structures for a LC microlens 46, 52 are illustrated. These structures are intended to be merely exemplary and do not represent an exhaustive disclosure of possible microlens structures. Microlens 46, which is illustrated in FIG. 3 and referred to as asymmetric, includes one hole-patterned electrode 48 and one uniform electrode 50. Microlens 52, which is illustrated in FIG. 4 and referred to as symmetric, includes two hole-patterned electrodes 54, 56. Hole-patterned electrodes 48, 54, 56 may be fabricated from any electrically conductive, non-transparent thin film material. Aluminum is one such material that meets these criteria. Uniform electrode 50 may be fabricated from any electrically conductive, transparent thin film material. Indium tin oxide is a preferred material for uniform electrode 50.

The LC molecules are pretreated to attain a homogeneous initial alignment. When an electric field is applied, an axially inhomogeneous electric field is induced owing to the geometric structure of the hole(s). A schematic representation of the induced electric field lines is shown in FIGS. 3B and 4B for the asymmetric and symmetric microlens, respectively. The electric field aligns the LC molecules, so that a lens-like refractive index distribution may be created at proper applied voltages. Microlens structures 46, 52, therefore, may have lens-like properties for light having linear polarization parallel to the homogeneous alignment direction of the LC. When the applied voltage is changed, the refractive index distribution may also be changed, which may further result in a change in the focal length of the LC microlens.

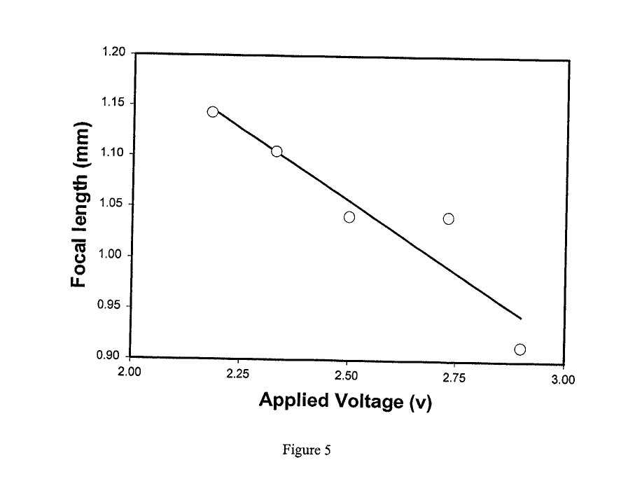

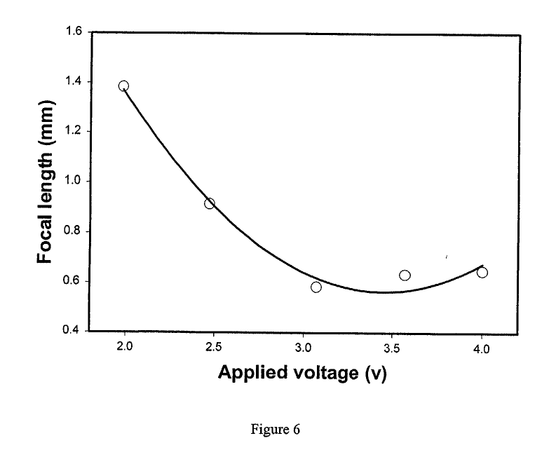

FIG. 5 is a plot of focal length versus applied voltage for an asymmetric LC microlens 46 in which the lens diameter (a) is 250 μm and the cell thickness (d) is 100 μm. In this example, increasing the applied voltage from about 2.2 to about 2.9 volts, reduces the focal length of asymmetric LC microlens 46 from about 1.15 to about 0.95 mm. FIG. 6 is a plot of focal length versus applied voltage for a symmetric LC microlens 52 in which the lens diameter (a) is 250 μm and the cell thickness (d) is 100 μm. In this example, increasing the applied voltage from about 2.0 to about 3.0 volts, reduces the focal length of symmetric microlens 52 from about 1.4 to about 0.6 mm. Based on these examples, it is clear that changing the applied voltage across a LC cell changes the focal length of both the asymmetric and symmetric microlenses. These examples are intended to be merely exemplary and are not intended to define a preferred embodiment or method of this invention.

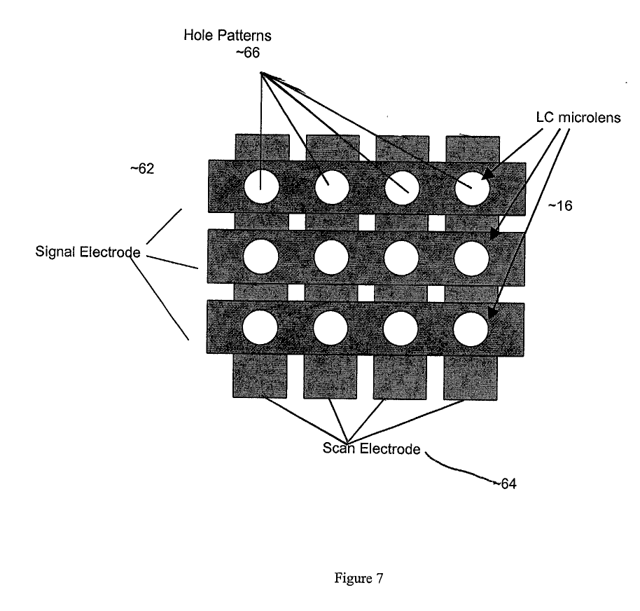

LC microlens arrays may be fabricated using mature LCD manufacturing technology. The uniform electrode strips used in conventional LCD flat panels, configured for passive matrix drive addressing, may be replaced by electrode strips 62, 64 including hole-patterns 66 (as illustrated in FIG. 7). The electrode hole-patterns may be prepared on one side (e.g. on the signal electrodes 62) of the liquid crystal element for an asymmetric microlens array (FIG. 3A) or on both sides (i.e. both signal and scan electrodes 62, 64) of the liquid crystal element for a symmetric microlens array (FIG. 4A).

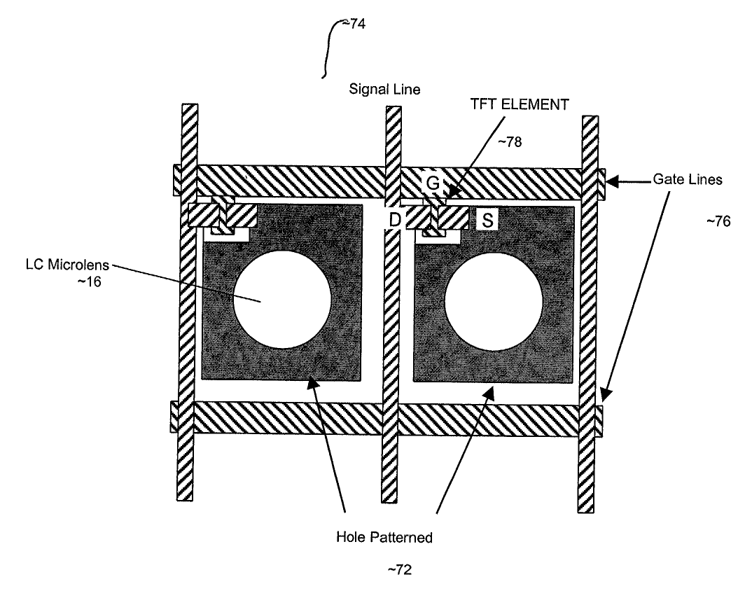

A LC microlens array may also be configured for active matrix drive addressing, such as presently used in conventional thin film transistor liquid crystal display (TFT LCD) flat panels (see FIG. 8). In this configuration, uniform electrode pixels in TFT LCD panels may be replaced by hole-patterned electrodes 72. The remainder of the structure, including the signal and gate lines 74, 76 and the TFT element 78 remain substantially identical to a conventional TFT LCD panel. The hole-patterned electrodes 72 may be prepared on one side of the liquid crystal element for an asymmetric microlens array (FIG. 3A) or on both sides of the liquid crystal element for a symmetric microlens array (FIG. 4A). FIG. 8, being a top view schematic, does not show the bottom side electrodes, however it will be understood by the skilled artisan that the microlens structure in the active matrix drive addressing configuration is similar to that illustrated in FIG. 3A or 4A in that each microlens includes a liquid crystal sandwiched between two electrodes. For both the passive and active matrix driving configurations, it is preferred that the electrode material be non-transparent on at least one side of the liquid crystal to eliminate unnecessary light beyond the hole patterns.

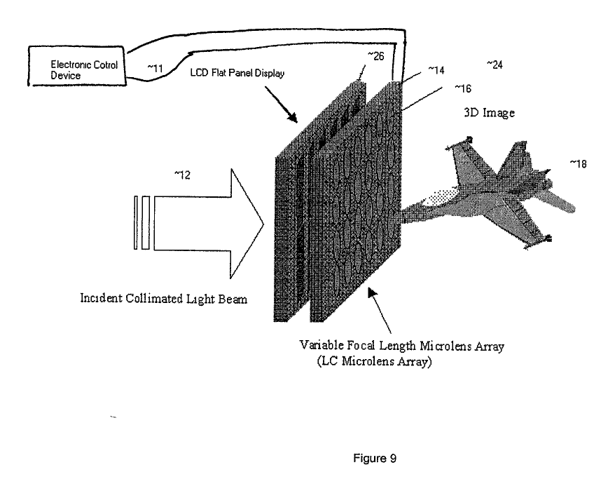

Referring now to FIG. 9, a second embodiment of the present invention is a light intensity controllable 3D volumetric display device 24. This embodiment 24 includes a microlens array 14 superposed with a LCD flat panel 26. It is preferred that the individual microlenses 16 in microlens array 14 and the individual pixels in LCD flat panel 26 have substantially identical spacing (i.e. the distance between the microlenses 16 should be about the same as the distance between the pixels) and are accurately aligned such that the optical axis M1 of each microlens 16 is coincident with the optical axis L1 of the corresponding pixel in the LCD flat panel 26. Embodiment 24 may be advantageous in that the LCD flat panel 26 enables the light intensity at each microlens 16 to be controlled, which may enable higher quality (i.e. more life-like) 3D images to be projected. LCD panel 26 of embodiment 24 may be monochromatic or full color. A monochromatic LCD panel 26 enables the projection of 3D images in either a gray scale or a single color (e.g. red, green or blue). A full color LCD panel 26 enables the projection of full color 3D images. A further advantage of embodiment 24 is that it is relatively compact, flat and light weight compared to many prior art devices.

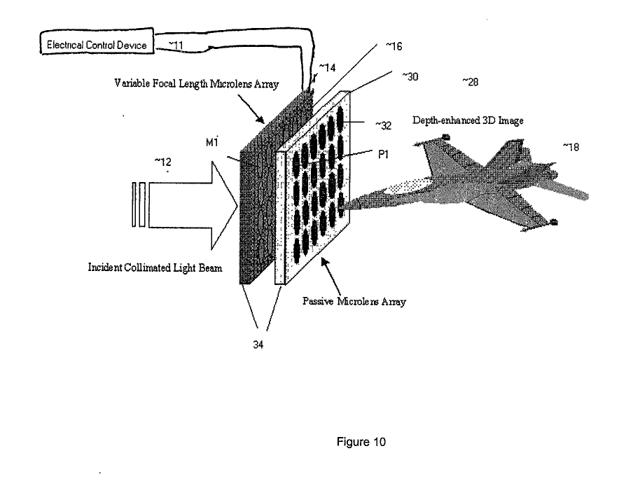

Referring now to FIG. 10, a third embodiment of the present invention is a depth-enhanced 3D volumetric display device 28. Embodiment 28 includes a variable focal length microlens array 14 in combination with a passive microlens array 30. Passive microlens array 30 is passive in that it is a constant focal length microlens array, such as the commercially available glass microlens array sold and manufactured by such as NSG America, Inc. (27 World's Fair Drive, Somerset, N.J. 08873). Passive microlens array 30 may be positioned on either the optically upstream or optically downstream side of microlens array 14. It is preferred that the individual microlenses 16 in microlens array 14 and the individual microlenses 32 in passive microlens array 30 have substantially identical spacing (i.e. the distance between them should be about the same) and are accurately aligned (i.e. having coincident optical axes M1, P1), such as described hereinabove with respect to FIG. 10. Careful control of the distance 34 between the two microlens arrays enables the effective variable depth range of the resulting light points to be substantially greater than microlens array 14 can provide alone, such as described hereinbelow. Embodiment 28 may therefore provide for the projection of substantially deeper objects.

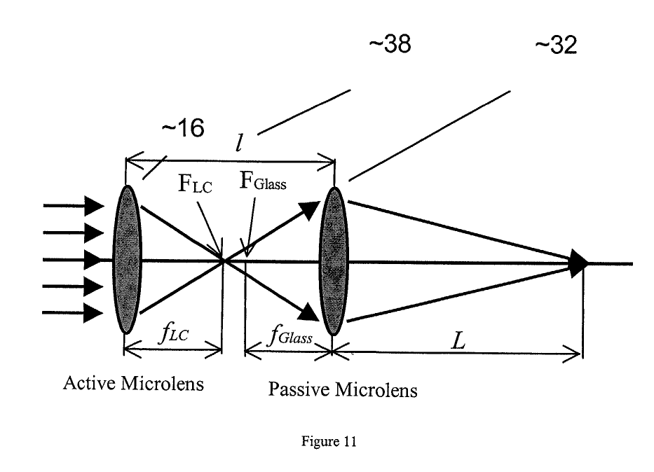

FIG. 11 illustrates the function of embodiment 28. For the purpose of this example, passive microlens 32 is positioned optically downstream of microlens 16 at a distance (l) 38. Passive microlens 32 may also be positioned on the opposite side (i.e. optically upstream) of microlens 16. The focal point of microlens 16 is imaged by passive microlens 32 to a distance (L) 40 from passive microlens 32. The final focal length (L) 40 may be calculated by the following equation.

$$L = \frac{{f}_{Glass} ( l - {f}_{LC} )}{l - {f}_{LC} - {f}_{Glass}} . \qquad ( 1 )$$

Based upon Equation (1), two conditions may considered; (i) l>f_{Glass}+maximum f_{LC} and (ii) l<f_{Glass}+minimum f_{LC}.

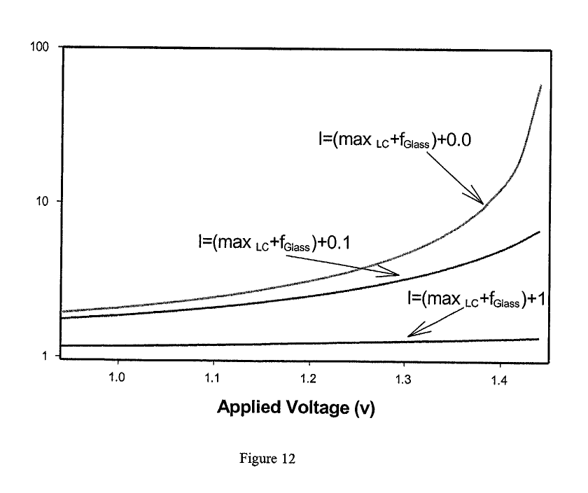

When l>f_{Glass}+maximum f_{LC}), the microlens arrangement is converging. FIG. 12 is a theoretical plot of L 40 on a logarithmic scale versus f_{LC}, wherein the distance between the back focal point of the LC microlens and the front focal point of passive microlens (x=l−f_{Glass}−f_{LC}) is 0.01 mm, 0.1 mm and 1 mm. It is shown that the variable range of final focal length (L) 40 may be substantially greater than that of the LC microlens 16 alone when x is small (e.g. 0.01 mm in the present example). It is also shown that the variable range of L 40 may not be substantially extended when x is large (e.g. 1.0 mm in the present example). Therefore, the separation distance between the microlens arrays 38, may enable the variable focal length range to be tuned to an appropriate value for the practical requirements of a particular application.

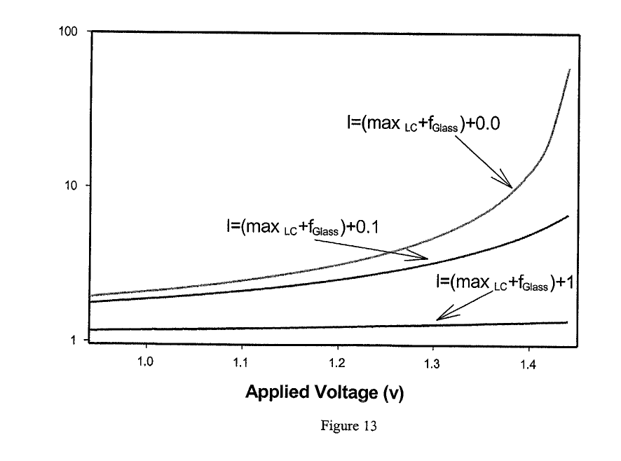

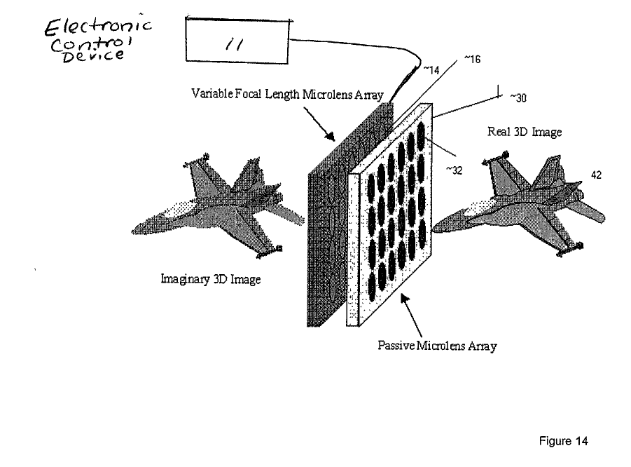

When l<f_{Glass}+minimum f_{LC}), the microlens arrangement is diverging, an imaginary image may appear on the optically upstream side of the device, such as shown in FIG. 14, discussed in greater detail hereinbelow. FIG. 13 is a theoretical plot of the final focal length (L) 40 on a logarithmic scale versus the focal length of microlens 16 (f_{LC}), wherein the focal points of two microlenses overlap (i.e. x=l−f_{Glass}−f_{LC}<0) by 0.01 mm, 0.1 mm and 0.2 mm. In this example the minimum value of the focal length of the LC microlens 16 (f_{LC}) is 0.94 mm. Again, a wide variable range of the final focal length (L) 40 may be achieved, although for an imaginary image in this configuration.

FIG. 14 illustrates the ability of the disclosed 3D volumetric display device to generate a real image 42 and an imaginary image 44 according to the arrangement of passive microlens array 30 and active microlens array 14. As mentioned hereinabove, when the distance between the two microlenses is greater than f_{Glass}+maximum f_{LC}, the light rays converge to a focal point at a distance L 40 from passive microlens 32. The converging embodiment therefore generates a luminous 3D volumetric image on the optically downstream side of the device. This image is said to be real. Conversely, when the distance between the two microlenses is less than f_{Glass}+minimum f_{LC}, the light rays will diverge to infinity on the optically downstream side of passive microlens 32. These rays appear to come from an object optically upstream of passive microlens 32. In the diverging embodiment no actual luminous 3D volumetric image is present. The image that appears optically upstream of the device is therefore said to be imaginary. A more thorough discussion of real versus imaginary images can be found in Hecht, Optics, 2^{nd} Edition, Addison-Wesley Publishing Company, Ch. 5.2, p. 129-149 (1987), which is herein fully incorporated by reference.

The modifications to the various aspects of the present invention described above are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A three-dimensional volumetric display system comprising:
a microlens array; and
an electrical control device that controls a depth position of individual volume points of a 3D volumetric image.

2. The display system of claim 1 wherein said electrical control device controls a focal length of individual microlenses within said microlens array to control said position of said individual volume points.

3. The display system of claim 2 wherein said electrical control device comprises an adjustable voltage.

4. The display system of claim 2 wherein said microlens array comprises a plurality of liquid crystal microlenses.

5. The display system of claim 4 wherein said microlens array is configured for passive matrix drive addressing.

6. The display system of claim 4 wherein said microlens array is configured for active matrix drive addressing.

7. The display system of claim 4 wherein said plurality of liquid crystal microlenses comprises a plurality of asymmetric liquid crystal microlenses.

8. The display system of claim 7 wherein each of said asymmetric liquid crystal microlenses includes one hole-patterned electrode.

9. The display system of claim 8 wherein said hole-patterned electrode is an aluminum hole-patterned electrode.

10. The display system of claim 7 wherein each of said asymmetric liquid crystal microlenses includes one indium tin oxide electrode.

11. The display system of claim 4 wherein said plurality of liquid crystal microlenses is a plurality of symmetric liquid crystal microlenses.

12. The display system of claim 11 wherein each of said symmetric liquid crystal microlenses includes two hole-patterned electrodes.

13. The display system of claim 12 wherein at least one of said hole-patterned electrodes is an aluminum hole-patterned electrode.

14. The display system of claim 4 wherein said plurality of liquid crystal microlenses each have a diameter from about 100 to about 500 microns.

15. The display system of claim 4 wherein said plurality of liquid crystal microlenses each have a cell thickness from about 50 to about 200 microns.

16. The display system of claim 2 further comprising a LCD flat panel superposed with said microlens array.

17. The display system of claim 16 wherein the optical axis of each microlens in said microlens array is coincident with the optical axis of the corresponding pixel in said LCD flat panel.

18. The display system of claim 2 further comprising an other microlens array superposed with said microlens array, said other microlens array being a passive microlens array.

19. The display system of claim 18 wherein the optical axis of each microlens in said microlens array is coincident with the optical axis of the corresponding microlens in said other microlens array.

20. The display system of claim 19 having a range of focal lengths from about 1 to about 100 mm.

21. The display system of claim 19 wherein said microlens array and said other microlens array are positioned such that a real three-dimensional image is generated.

22. The display system of claim 19 wherein said microlens array and said other microlens array are positioned such that an imaginary three-dimensional image is generated.

23. The display system of claim 2 further comprising:
a LCD flat panel; and
a other microlens array, wherein said other microlens array is a passive microlens array;
wherein said microlens array, said other microlens array and said LCD flat panel are superposed with one another;
wherein the optical axis of each microlens in said microlens array is coincident with the optical axis of the corresponding microlens in said other microlens array and with the optical axis of the corresponding pixel in said LCD flat panel.

24. A three-dimensional volumetric display system comprising:
a variable focal length microlens array, said microlens array including a plurality of liquid crystal microlenses; and
an electrical control device, wherein said electrical control device controls a focal length of individual microlenses within said microlens array, said electrical control device including an adjustable voltage.

25. A method for displaying a three-dimensional volumetric image comprising:
projecting an image through a display system, said display system including a microlens array; and
electrically controlling a position of individual volume points of said volumetric image by means of an electrical control device.

26. The method of claim 25 wherein said electrical control device controls a focal length of individual microlenses within said microlens array.

27. The method of claim 26 wherein said electrical control device comprises an adjustable voltage.

28. The method of claim 26 wherein said microlens array comprises a plurality of liquid crystal microlenses.

29. The method of claim 28 wherein said microlens array is configured for passive matrix drive addressing.

30. The method of claim 28 wherein said microlens array is configured for active matrix drive addressing.

31. The method of claim 28 wherein said microlens array comprises a plurality of asymmetric liquid crystal microlenses.

32. The method of claim 28 wherein said microlens array comprises a plurality of symmetric liquid crystal microlenses.

33. The method of claim 28 wherein said plurality of liquid crystal microlenses each have a diameter from about 100 to about 500 microns.

34. The method of claim 28 wherein said plurality of liquid crystal microlenses each have a cell thickness from about 50 to about 200 microns.

35. The method of claim 26 wherein said three-dimensional volumetric image is projected through said microlens array by means of a LCD flat panel, said LCD flat panel being superposed with said microlens array.

36. The method of claim 35 wherein the optical axis of each microlens in said microlens array is coincident with the optical axis of the corresponding pixel in said LCD flat panel.

37. The method of claim 26 wherein said display system further comprises a other microlens array superposed with said microlens array, said other microlens array being a passive microlens array.

38. The method of claim 37 wherein the optical axis of each microlens in said microlens array is coincident with the optical axis of the corresponding microlens in said other microlens array.

39. The method of claim 38 wherein said display system has a range of focal lengths from about 1 to about 100 mm.

40. The method of claim 38 wherein said microlens array and said other microlens array are positioned such that a real three dimensional image is generated.

41. The method of claim 38 wherein said microlens array and said other microlens array are positioned such that an imaginary three-dimensional image is generated.

42. The method of claim 26 wherein:
said image is projected through said microlens array by means of a LCD flat panel, said LCD flat panel being superposed with said microlens array;
said display system further comprises a other microlens array, wherein said other microlens array is a passive microlens array;
said microlens array, said other microlens array and said LCD flat panel are superposed with one another;
the optical axis of each microlens in said microlens array is coincident with the optical axis of the corresponding microlens in said other microlens array and with the optical axis of the corresponding pixel in said LCD flat panel.
